(19) United States
(12) Patent Application Publication
(10) Pub. No.: US 2011/0176302 A1
(43) Pub. Date: Jul. 21, 2011

(54) ELECTRONIC READING DEVICE

(75) Inventor: SHU-HUA LIAO, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/834,024

(22) Filed: Jul. 12, 2010

(30) Foreign Application Priority Data
Jan. 19, 2010 (CN) 201010300426.0

(51) Int. Cl. F21V 14/04

(52) U.S. Cl. 362/232

(57) ABSTRACT

An electronic reading device includes a frame, a reflective display, and a lighting device connected to the frame. The lighting device includes a plurality of light emitters, and a light reflector. The light reflector includes a supporting member rotatably connected to the frame, a connecting member, and a reflective member that are rotatably connected in cascade. The reflective member includes a reflective surface, and the reflective member is capable of being rotated to a position to allow the reflective surface to reflect light emitted by the plurality of light emitters on the reflective display.

### BACKGROUND

1. Technical Field

The present disclosure relates to electronic reading devices and, particularly, to an electronic reading device with a light.

2. Description of Related Art

Electronic reading devices that include a reflective display (i.e., an electrophoretic electronic paper) are very common today. The reflective display has no backlight module and uses ambient light as light source. When the ambient light is low, it is difficult to view the content on the reflective display. Auxiliary lighting devices have been developed for illuminating the reflective display to overcome this shortcoming. Although the conventional auxiliary lighting devices satisfy the basic requirement, it is still desirable to provide an electronic reading device that includes a light for its reflective display.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of an electronic reading device according to an exemplary embodiment.

FIG. 2 is a partially exploded view of the electronic reading device of FIG. 1, showing a lighting device.

FIG. 3 is a schematic, isometric view of a light reflector of the lighting device of FIG. 2.

FIG. 4 is a schematic, isometric view showing the light reflector in a first state.

FIG. 5 is a schematic, isometric view showing the light reflector in a closed state.

### DETAILED DESCRIPTION

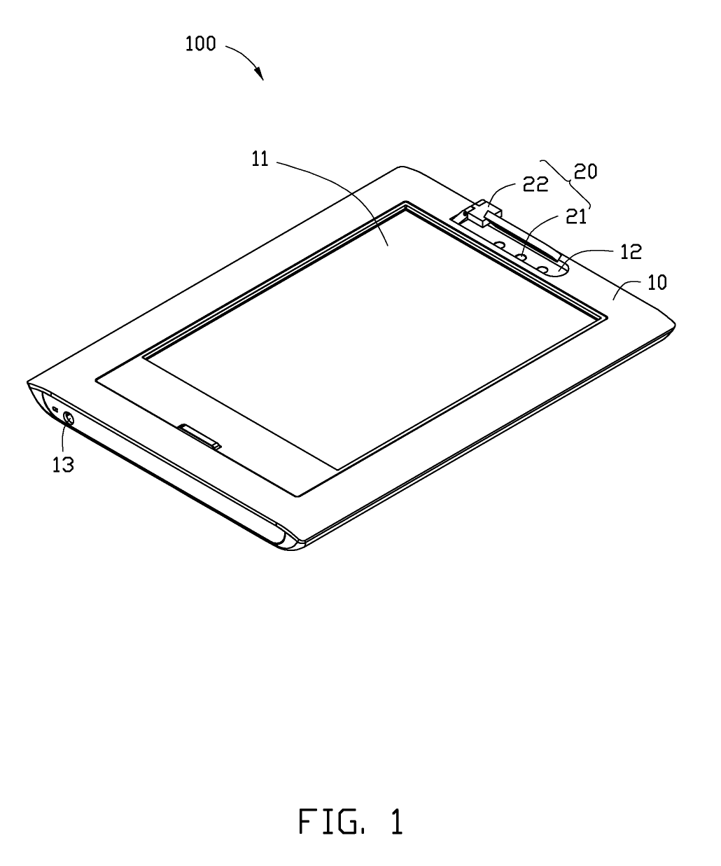

Referring to FIG. 1, an electronic reading device 100 includes a frame 10, a reflective display 11, and a lighting device 20 rotatably connected to the frame 10. A recess 12 is defined in the frame 10 to accommodate the lighting device 20. The lighting device 20 includes a plurality of light emitters 21, such as light-emitting diodes (LEDs), and a light reflector 22. The light emitters 21 can be fixed in the bottom of the recess 12. The light emitters 21, connect to an internal power source (not shown) of the device 100 or can also be connected to a power receptacle 13 via internal cables.

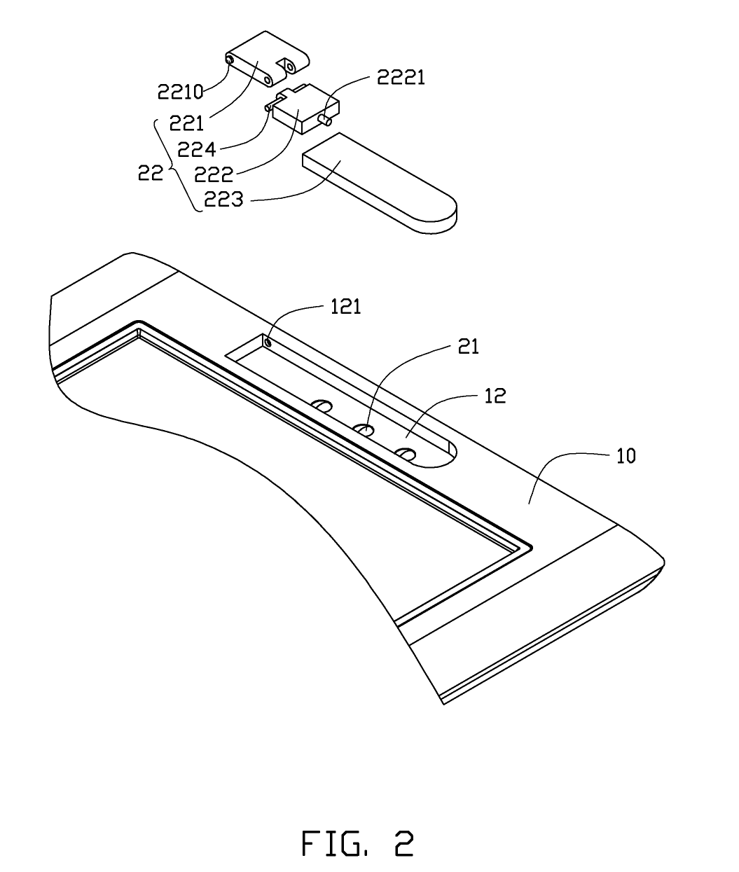

Referring to FIG. 2, the light reflector 22 includes a supporting member 221, a connecting member 222, and a reflective member 223, rotatably connected in that order. The supporting member 221 is rotatably connected to the frame 10, in the embodiment, the supporting member 221 defines a pair of axles 2210 at opposite sides of an end thereof. Each axle 2210 is rotatably inserted respectively in a receiving hole 121 defined in the wall of the recess 12, allowing the supporting member 221 to be rotatably connected to the frame 10. An end of the supporting member 221 opposite to the end with the axles 2210 is rotatably connected to an end of the connecting member 222 via a pivot 224.

The connecting member 222 defines a post 2221 on an end opposite to the end connected to the supporting member 221. The post 2221 is substantially perpendicular to the pivot 224 and is rotatably inserted into a hole (not shown) defined in an end surface of the reflective member 223, allowing the reflective member 223 to rotate about the post 2221. Friction exists between the recess 12 and the supporting member 221, the supporting member 221 and the connecting member 222, and the connecting member 222 and the reflective member 223, allowing the supporting member 221, the connecting member 222, and the reflective member 223 to be set at any desired position in their respective motion range.

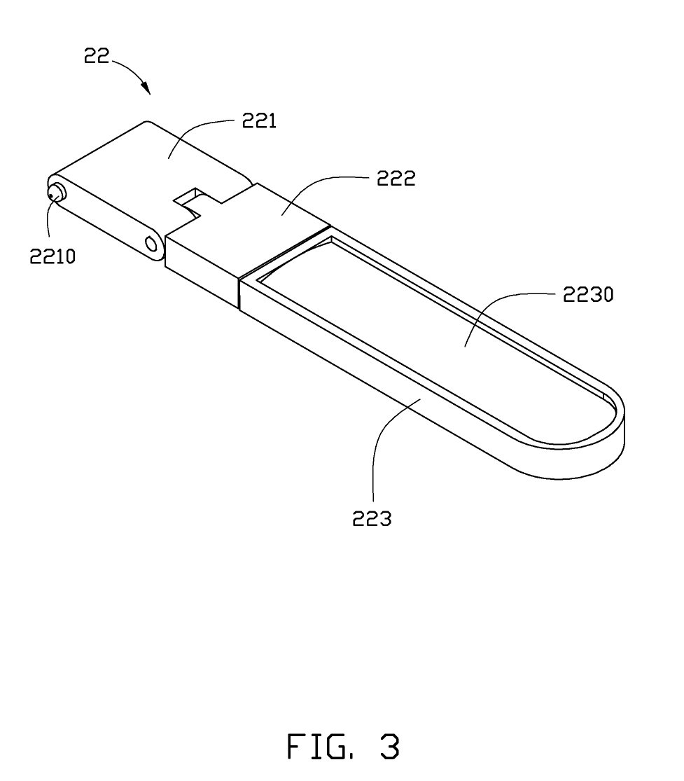

Referring to FIG. 3, the reflective member 223 includes a reflective surface 2230. When in use, the reflective member 223 can be adjusted to a suitable orientation to allow the reflective surface 2230 to reflect light emitted by the plurality of the light emitters 21 to the display surface of the display 11. In the embodiment, the reflective surface 2230 can be a convex mirror. The light diverges after being reflected by the convex mirror, to light most of the display 11.

When the ambient light is low, the light emitters 21 can be turned on and the light reflector 22 can be orientated in a suitable position until sufficient light is reflected on the display 11.

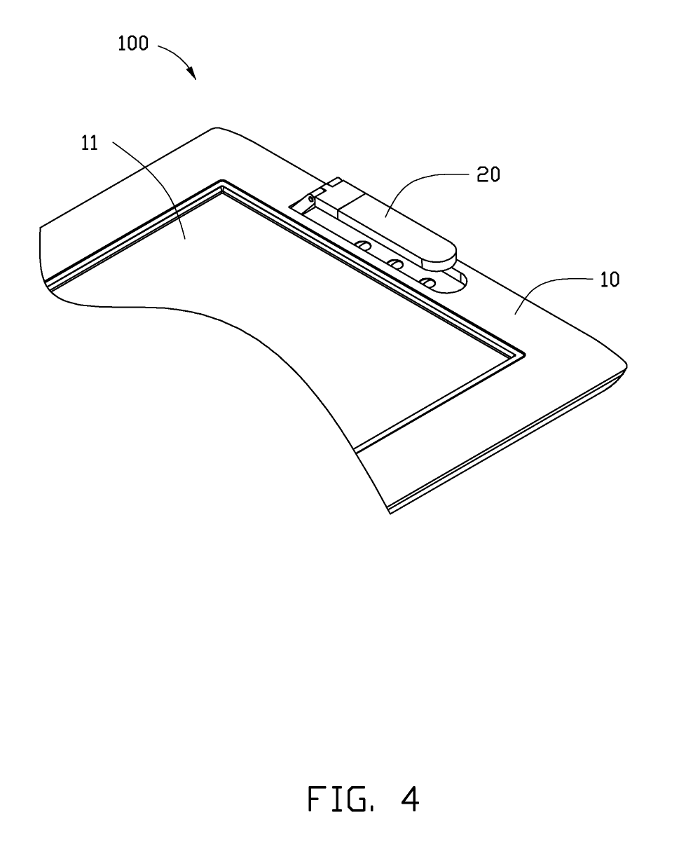

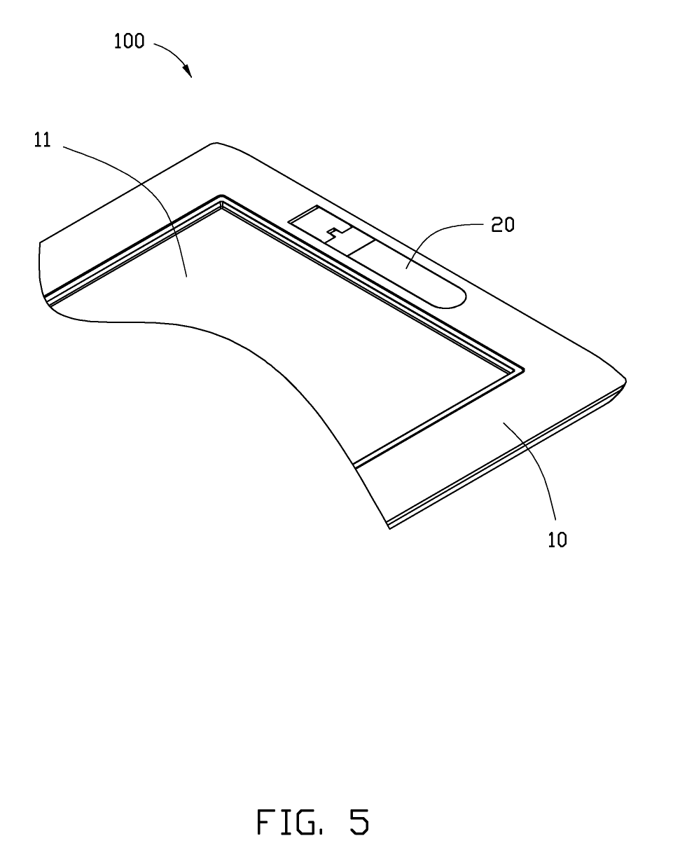

Referring to FIGS. 4 and 5, after use, the light reflector 22 can be adjusted to be fully received in the recess 12 with the reflective surface 2230 facing the bottom of the recess 12, preventing the reflective surface 2230 from being damaged.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic reading device comprising:
a frame;
a reflective display; and
a lighting device connected to the frame, the lighting device comprising:
a plurality of light emitters; and
a light reflector comprising a supporting member, a connecting member, and a reflective member, rotatably connected in that order;
wherein the supporting member is rotatably connected to the frame; the reflective member comprises a reflective surface, and the reflective member is capable of being rotated to a position to allow the reflective surface to reflect light emitted by the plurality of the light emitters on the reflective display.

2. The electronic reading device of claim 1, wherein the frame defines a recess to accommodate the lighting device.

3. The electronic reading device of claim 2, wherein the supporting member defines a pair of axles at opposite sides of an end thereof, and each axle is rotatably inserted respectively in a receiving hole defined in the wall of the recess, allowing the supporting member to be rotatably connected to the frame.

4. The electronic reading device of claim 3, wherein an end of the supporting member opposite to the end with the axles is rotatably connected to an end of the connecting member via a pivot.

5. The electronic reading device of claim 4, wherein the connecting member defines a post on an end opposite to the end connected to the supporting member, and the post is substantially perpendicular to the pivot and is rotatably inserted into a hole defined in an end surface of the reflective member, allowing the reflective member to rotate about the post.

6. The electronic reading device of claim 5, wherein friction exists between the frame and the supporting member, the supporting member and the connecting member, and the connecting member and the reflective member, allowing the supporting member, the connecting member, and the reflective member to be set in their respective desired positions.

7. The electronic reading device of claim 1, wherein the reflective surface is a convex mirror.

8. The electronic reading device of claim 2, wherein the light emitters are light-emitting diodes, and are arranged and fixed in the bottom of the recess.

9. An electronic reading device comprising:
a frame defining a recess;
a reflective display mounted on the frame; and
a lighting device rotatably connected to the frame, the lighting device comprising:
a light source; and
a light reflector to reflect light emitted from the light source,
wherein, the lighting device is configured to be received in the recess when it is not in use.

10. The electronic reading device of claim 9, wherein,
the light reflector comprises a supporting member, a connecting member, and a reflective member, rotatably connected in that order; and
the supporting member is rotatably connected to the frame; the reflective member comprises a reflective surface, and the reflective member is capable of being rotated to a position to allow the reflective surface to reflect light emitted by the plurality of the light emitters on the reflective display.
